(19) United States
(12) Patent Application Publication
(10) Pub. No.: US 2011/0216049 A1
(43) Pub. Date: Sep. 8, 2011

(54) VISIBLE LIGHT COMMUNICATION APPARATUS AND METHOD

(76) Inventors: Tae-Jong JUN, Suwon-si (KR); Jong-Seo Lee, Hwaseong-si (KR); Jung-Suk Han, Hwaseong-si (KR); Joo-Young Lee, Seoul (KR); Soo-Lin Kim, Seoul (KR)

(21) Appl. No.: 13/036,300

(22) Filed: Feb. 28, 2011

(30) Foreign Application Priority Data
Mar. 2, 2010 (KR) 10-2010-0018528

(51) Int. Cl. G09G 5/00; G09G 3/36

(52) U.S. Cl. 345/207; 345/102

(57) ABSTRACT

Provided is a visible light communication apparatus. The visible light communication apparatus includes: a display unit that displays an image according to an image signal; a light source unit that operates as a backlight for the display unit, generates an optical signal by driving a light source based on a data signal, and outputs the generated optical signal to the display unit; a sensor unit that detects a region corresponding to a shape of a terminal which touches or approaches the display unit; and an image signal conversion unit that converts the image signal such that an image displayed in the region detected by the sensor unit is converted to a bright image having a gray level higher than a predetermined reference gray level.

This application claims priority to Korean Patent Application No. 10-2010-0018528 filed on Mar. 2, 2010 in the Korean Intellectual Property Office, the disclosure of which is incorporated herein by reference in its entirety.

### BACKGROUND OF THE INVENTION

1. Field of the Invention

The present invention relates generally to visible light communication. More particularly, the present invention relates to a visible light communication apparatus which transmits or receives data by using the backlight of a non self-luminous display device such as a liquid crystal display (LCD).

2. Description of the Related Art

Visible light communication is communication technology that uses visible light to transmit information. In visible light communication, data is transmitted by using visible light emitted from a light source, such as a lighting device or a backlight included a display device, where the light source transmits the data via rapid sets of pulses that are transmitted too quickly to be seen by the naked eye.

In visible light communication, frequency allocation is unnecessary, and a large amount of data can be transmitted at high speed by this high-speed flickering of a light source. Due to these advantages, visible light communication is drawing attention in short-distance wireless communication, particularly in unidirectional information provision systems.

Attempts have been made to apply visible light communication to display devices such as liquid crystal displays (LCDs). However, no display device employing visible light communication has been introduced yet, and virtually no research has been conducted on communication range, communication speed, communication quality, and the like.

### SUMMARY OF THE INVENTION

Aspects of the present invention provide a visible light communication apparatus and method, in which data is transmitted and received by using a backlight of a display device as a light source for data transmission.

However, aspects of the present invention are not restricted to the ones set forth herein. The above and other aspects of the present invention will become more apparent to one of ordinary skill in the art to which the present invention pertains by referencing the detailed description of the present invention given below.

According to an aspect of the present invention, there is provided a visible light communication apparatus including: a display unit that displays an image according to an image signal; a light source unit that operates as a backlight for the display unit, generates an optical signal by driving a light source based on a data signal, and outputs the generated optical signal to the display unit; a sensor unit that detects a region corresponding to a shape of a terminal which touches or approaches the display unit; and an image signal conversion unit that converts the image signal such that an image displayed in the region detected by the sensor unit is converted to a bright image having a gray level higher than a predetermined reference gray level.

According to another aspect of the present invention, there is provided a visible light communication apparatus including: a display unit having a plurality of display blocks on which an image is to be displayed; a light source unit having a plurality of light source blocks which correspond respectively to the display blocks, wherein each of the light source blocks is configured to output an optical signal to a corresponding one of the display blocks; and a sensor unit that identifies a display block corresponding to a position of a terminal which touches or approaches the display unit, wherein the light source unit is configured to generate an optical signal by driving the light source block corresponding to the identified display block, wherein the driving is based on a data signal of a broadcast signal, and wherein the driving outputs the generated optical signal to the identified display block.

According to another aspect of the present invention, there is provided a visible light communication method including: displaying an image on a display unit according to an image signal; detecting a terminal touching or approaching the display unit; detecting a region corresponding to a shape of the terminal that touches or approaches the display unit; converting the image signal such that an image displayed in the detected region is converted to a bright image having a gray level higher than a predetermined reference gray level; generating an optical signal by driving a light source based on a data signal; and outputting the generated optical signal to the display unit.

According to another aspect of the present invention, there is provided a visible light communication method including: displaying an image on a display unit according to an image signal, the display unit having a plurality of display blocks; detecting a terminal touching or approaching any one of the display blocks; identifying a display block corresponding to a position of the touching or approaching terminal; generating an optical signal by driving a light source block that corresponds to the identified display block, wherein the driving is based on a data signal; and outputting the generated optical signal to the identified display block.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram illustrating the configuration of a visible light communication apparatus according to an exemplary embodiment of the present invention;

FIG. 2 is a diagram illustrating examples of a waveform of a converted data signal according to an exemplary embodiment of the present invention;

FIG. 3 is a diagram illustrating the concept of image conversion performed by the visible light communication apparatus of FIG. 1;

FIG. 4 is a flowchart illustrating a visible light communication method according to an exemplary embodiment of the present invention;

FIG. 5 is a diagram illustrating the configuration of a visible light communication apparatus according to another exemplary embodiment of the present invention;

FIG. 6 is a diagram illustrating the concept of data transmission performed by the visible light communication apparatus of FIG. 5; and

FIG. 7 is a flowchart illustrating a visible light communication method according to another exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. In some embodiments, well-known processes, structures, and technologies will not be specifically described in order to avoid ambiguous interpretation of the present invention. Like reference numerals refer to like elements throughout the specification.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” or “beneath” can encompass both an orientation of above and below. The device may be otherwise oriented and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, a visible light communication apparatus according to the present invention will be briefly described before proceeding to a detailed description of the present invention. An exemplary visible light communication apparatus according to the present invention is an image display apparatus (e.g., a liquid crystal display (LCD)) which includes a backlight that transmits data in addition to carrying out the typical function of providing light to a display unit (e.g., a liquid crystal panel). For the data transmission function of the backlight, a broadcast signal into which an image signal and a data signal are multiplexed may be output.

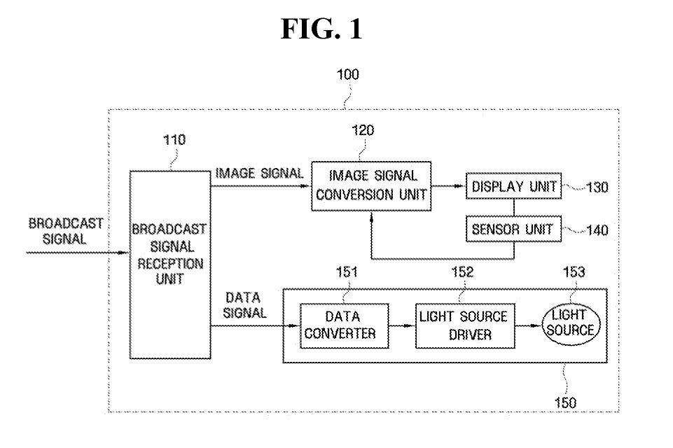

Hereinafter, a visible light communication apparatus according to an exemplary embodiment of the present invention will be described with reference to FIGS. 1 through 3.

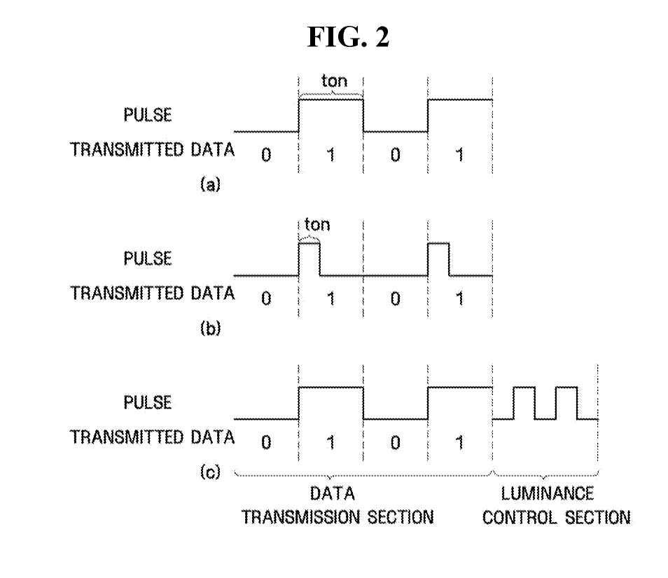

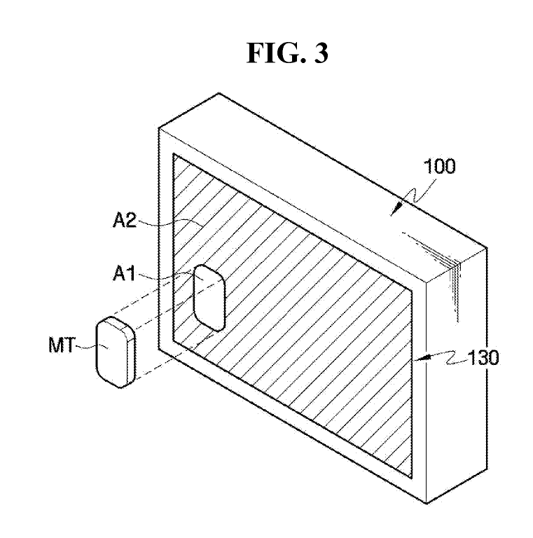

FIG. 1 is a diagram illustrating the configuration of a visible light communication apparatus 100 according to an exemplary embodiment of the present invention. FIG. 2 is a diagram illustrating examples of a waveform of a converted data signal according to an exemplary embodiment of the present invention. FIG. 3 is a diagram illustrating the concept of image conversion performed by the visible light communication apparatus 100 of FIG. 1.

Referring to FIG. 1, the visible light communication apparatus 100 includes a broadcast signal reception unit 110, an image signal conversion unit 120, a display unit 130, a sensor unit 140, and a light source unit 150.

The broadcast signal reception unit 110 receives a broadcast signal through a cable, an antenna, power line communication (PLC), a local area network (LAN), or the like, and checks whether the received broadcast signal includes a data signal.

When the received broadcast signal does not include a data signal, the broadcast signal reception unit 110 separates an image signal from the received broadcast signal and outputs the image signal to the display unit 130. In this case, the visible light communication apparatus 100 functions only as an image display apparatus.

When the received broadcast signal includes a data signal, the broadcast signal reception unit 110 separates the image signal and the data signal from the received broadcast signal. It then outputs the image signal to the display unit 130 and outputs the data signal to the light source unit 150.

The display unit 130 displays an image according to the input image signal and may be, for example, a liquid crystal panel. The display unit 130 may display the image by projecting light emitted from the light source unit 150, which will be described later.

The sensor unit 140 is a touch-sensitive unit that senses whether a terminal desiring to receive the data signal has touched or approached the display unit 130. Here, the term ‘touch’ denotes that the terminal is in direct contact with the display unit 130, and the term ‘approach’ denotes that the terminal is not in direct contact with the display unit 130 but is close enough to cast a shadow on the display unit 130, for example, located within approximately 10 cm from the display unit 130. To sense the touch or approach of the terminal, the sensor unit 140 may be implemented as a touch panel or an illuminance sensor.

To sense the touch or approach of the terminal, the sensor unit 140 a two-dimensional (2D) shape which corresponds to a touch surface or an approach surface of the terminal which touches or approaches the display unit 130. That is, the terminal will either contact an area of the display unit 130, or cast a shadow upon it. Either way, the terminal will have some effect upon a 2D area of the display unit 130. The sensor unit 140 may detect this region as follows.

For example, when the terminal touches the display unit 130, the sensor unit 140 may transmit a sensing signal to the display unit 130 from behind the display unit 130, detect a 2D shape of the touched terminal based on the terminal's reflection of the sensing signal, and determine the region of the display unit 130 which corresponds to the detected 2D shape. Alternatively, the sensor unit 140 may determine the 2D shape of the terminal by obtaining and combining information about all locations on the display unit 130 touched by the terminal, and may determine the region of the display unit 130 which corresponds to the detected 2D shape.

When the terminal does not touch but rather approaches the display unit 130, the sensor unit 140 may sense the region of the display unit 130 whose illuminance has changed due to the shadow of the terminal which approaches the display unit 130. That is, it may determine the 2D shape of the shadow of the approaching terminal. It may also detect a region of the display unit 130 which corresponds to the detected 2D shape.

Once it detects a region corresponding to the shape of the terminal which touches or approaches the display unit 130, the sensor unit 140 outputs an image conversion signal to the image signal conversion unit 120.

In response to the input image conversion signal, the image signal conversion unit 120 converts the image signal and outputs the converted image signal to the display unit 130. Here, the image signal conversion unit 120 converts the image signal such that the image displayed in the region detected by the sensor unit 140 is converted into a bright image, that is, an image having a gray level higher than some predetermined reference gray level. The display unit 130 displays an image according to the converted image signal. Thus, in the region corresponding to the detected shape of the terminal, the display unit 130 displays its image at a gray level higher than the reference gray level. If the image already has a gray level at or above the reference gray level, then the image is left unmodified, i.e. if the image is already sufficiently bright, it is not further brightened. The need for such image conversion arises because when an image displayed on the display unit 130 is a dark image having a low gray level (e.g., a full-black image), even if the terminal touches or approaches the display unit 130 to receive data, it is difficult for the terminal to sense an optical signal due to a lack of light, thus causing visible light communication to stop or to be compromised.

However, if image conversion is performed as in the current exemplary embodiment, since a region of the display unit 130 which is touched or approached by the terminal is a relatively bright region having a high gray level, there is sufficient light to carry out effective visible light communication. Accordingly, the terminal can easily sense an optical signal, and thus visible light communication can be performed stably without interruption and at high speed. Additionally, the bright region does not extend beyond the shape of the terminal. Therefore, the region does not irritate a person who is watching an image displayed on the display unit 130.

Here, an image having a gray level higher than the reference gray level may be defined as an image in which a gray value of a blue color (among, for example, red, green and blue (RGB) colors) is higher than a predetermined reference gray value, where the gray value can be any value from 0 to 255 (the closer to 255, the higher the gray value). This is because a blue color wavelength has a high optical power value. That is, it is easier for the terminal to receive an optical signal from an image whose blue color has a high gray value.

An image having a gray level higher than the reference gray level may be a full-white image having an RGB gray value of (255, 255, 255) or a full-blue image having an RGB gray value of (0, 0, 255).

The light source unit 150 includes a light source 153, such as an LED, to provide light to the display unit 130. In addition, to transmit data, the light source unit 150 drives the light source 153 by turning on or off the light source 153 based on the input data signal. That is, an optical signal transmitted from the light source unit 150 to the display unit 130 is generated based on the data signal.

The optical signal generated based on the data signal is transmitted to one or more terminals (not shown) which desire to receive data through the display unit 130. Although not shown in the drawings, a terminal desiring to receive the data signal can include an optical sensor which receives an optical signal, and a demodulator which obtains the data signal by demodulating the received optical signal.

As described above, the terminal touches or approaches the display unit 130 to receive an optical signal generated based on a data signal. Accordingly, the communication range between the visible light communication apparatus 100 and the terminal is reduced, thereby improving communication quality.

The light source unit 150 includes a data converter 151, a light source driver 152, and the light source 153.

The data converter 151 receives a data signal, converts the data signal based on a data transmission protocol (e.g., the Ethernet protocol) that can be used in wireless optical communication, and outputs the converted data signal to the light source driver 152. Here, the data signal converted based on the data transmission protocol may be, for example, a series of ON/OFF pulses.

The light source driver 152 drives the light source 153 according to the converted data signal received from the data converter 151. The driving of the light source 153 is accomplished by turning on or off the light source 153 using a frequency at which the flickering of the light source 153 is unperceivable to the human eye. For example, when the light source driver 152 receives an ON/OFF pulse, the light source 153 may be turned on for a period of time corresponding to a pulse width of the ON signal, and may be turned off for a period of time corresponding to a pulse width of the OFF signal.

Here, the luminance of the light source 153 may be maintained or changed by adjusting the data transmission protocol. That is, the data converter 151 may convert a data signal by adjusting the data transmission protocol in view of required luminance. For example, the pulse width of the data signal can be altered according to required luminance. Alternatively, the data signal can be divided into a luminance control section in addition to a data transmission section. Examples of a waveform of the converted data signal will now be described with reference to FIG. 2.

Referring to (a) and (b) of FIG. 2, the luminance of the light source 153 can be reduced even though the same data pulses are transmitted. That is, the duration of the ON pulses can be increased or decreased, depending on whether the luminance of the light source 153 is to be raised or lowered. If the total ON time and the total OFF time of the converted data signal are maintained, the luminance of the light source 153 can be maintained unchanged. Here, the period of each bit of information does not change. Thus, if the duration of the ON signal is reduced by a certain amount, the duration of the OFF signal is raised by that same amount.

Alternatively, referring to (c) of FIG. 2, a converted data signal may include a data transmission section, which is based on a data signal that is to be actually transmitted, and a luminance control section which is to be used as a luminance control region, i.e., a dummy region that is not used for transmission of the data signal. The invention contemplates use of any bit sequences of any duration in the luminance control region.

The invention is not limited to the above methods, and may employ any suitable data transmission protocol used to convert data.

FIG. 3 is a diagram illustrating the concept of image conversion performed by the visible light communication apparatus 100 of FIG. 1. Referring to FIG. 3, an image is displayed on the display unit 130 of the visible light communication apparatus 100, and the light source unit 150 provides light to the display unit 130.

A terminal MT having an optical sensor touches or approaches the display unit 130, in order to receive an optical signal corresponding to a data signal. The sensor unit 140 detects region A1, corresponding to either the terminal MT itself, or its shadow. The image area A1 is converted into a bright image, regardless of the remaining image A2. Accordingly, the optical signal reception quality of the terminal MT is improved.

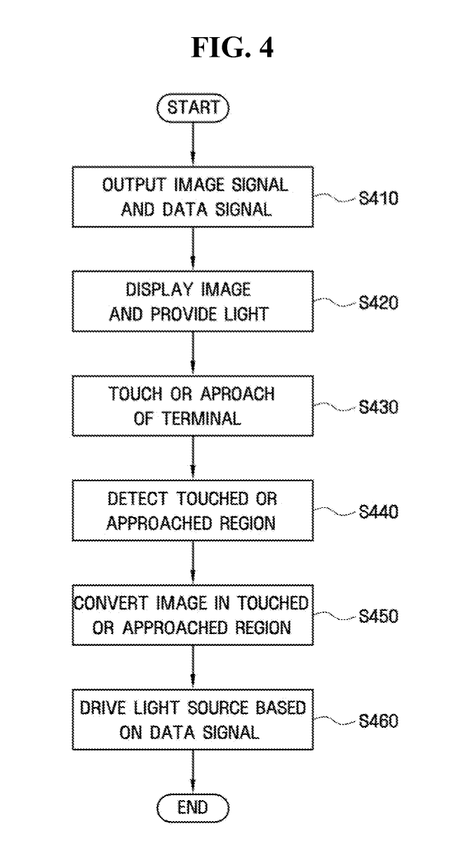

FIG. 4 is a flowchart illustrating a visible light communication method according to an exemplary embodiment of the present invention. Referring to FIG. 4, the broadcast signal reception unit 110 separates an image signal and a data signal from a broadcast signal, and outputs the image signal to the display unit 130 and the data signal to the light source unit 150 (operation S410). The display unit 130 displays an image according to the input image signal, with the light source unit 150 providing illumination as if it were a conventional backlight (operation S420). To fulfill this traditional backlight function, the light source 153 can employ any suitable illumination source, such as LEDs or the like.

Next, a terminal touches or approaches the display unit 130 (operation S430). The sensor unit 140 senses the touch or approach of the terminal on or to the display unit 130 by detecting a region corresponding to the shape of the terminal, and outputs an image conversion signal to the image signal conversion unit 120 (operation S440).

In response to receiving the image conversion signal, the image signal conversion unit 120 converts the image signal such that the image of the region detected by the sensor unit 140 is made brighter. That is, in the region detected by sensor unit 140, the image is made brighter by raising its gray level above some predetermined reference gray level (operation S450).

In addition to acting as a conventional backlight, the light source unit 150 also generates an optical signal by driving the light source 153 based on the data signal, so as to output an additional optical signal to the display unit 130 (operation S460). A method used by the light source unit 150 to output the optical signal is as described above with reference to FIG. 1. That is, the light source unit 150 converts the data signal to a series of light pulses according to a suitable data transmission protocol, and emits the light pulses from light source 153. The light source unit 150 controls the luminance of the light source 153 by adjusting the data transmission protocol. For example, the duration of each ON pulse can be increased or decreased as desired (up to the maximum duration of each data bit), to control the luminance of this light source block relative to the other light source blocks. In the context of this invention, the term “average” may include not only an arithmetic average of luminance values, but also any luminance value in any way representative of any of the luminances of the remaining light source blocks. Furthermore, adjustments to the data transmission protocol may include the altering of any parameter of the protocol, such as the period of each ON pulse, the period or frequency of the data bits, or the like. Similarly, the luminance control section can employ any duration and sequence of bits suitable for identifying a particular desired luminance.

The operations included in the visible light communication method according to the current exemplary embodiment need not necessarily be executed in the above order, and the order of the operations may vary.

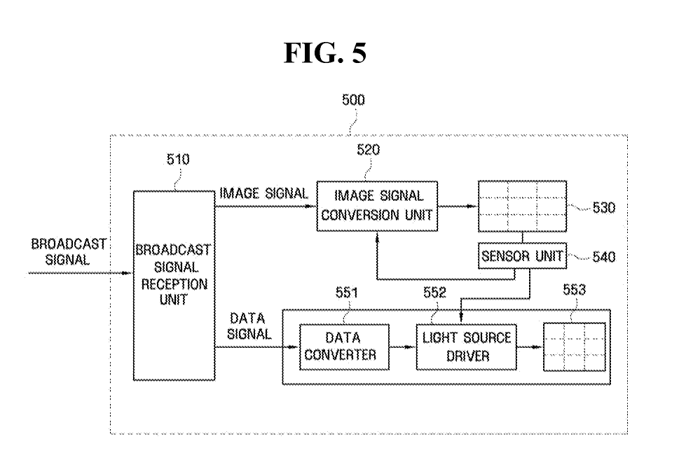

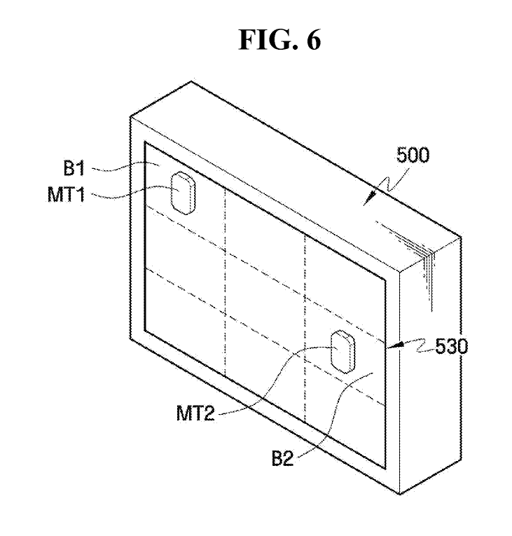

Hereinafter, a visible light communication apparatus according to another exemplary embodiment of the present invention will be described with reference to FIGS. 5 and 6. The visible light communication apparatus according to the current exemplary embodiment transmits data through a partial region of a display unit, that is, through a display block of the display unit. In particular, same or different data may be transmitted through one or more display blocks. For simplicity, a description of elements substantially identical to those of the previous embodiment described above with reference to FIGS. 1 through 3 will be omitted or simplified.

FIG. 5 is a diagram illustrating the configuration of a visible light communication apparatus 500 according to another exemplary embodiment of the present invention. Referring to FIG. 5, the visible light communication apparatus 500 includes a broadcast signal reception unit 510, an image signal conversion unit 520, a display unit 530, a sensor unit 540, and a light source unit 550.

The broadcast signal reception unit 510 receives a broadcast signal and separates an image signal and a data signal from the received broadcast signal. Then, the broadcast signal reception unit 510 outputs the image signal to the display unit 530 and the data signal to the light source unit 550.

The display unit 530 includes a plurality of display blocks which display an image according to the input image signal. The display unit 530 according to the current exemplary embodiment includes 3×3 display blocks, although any number and layout of such blocks is contemplated.

The sensor unit 540 senses whether a terminal desiring to receive the data signal has touched or approached the display unit 530. The sensor unit 540 also determines which display block corresponds to the location touched or approached by the terminal, and

outputs information about the detected display block to a light source driver 552 such that a light source block corresponding to the detected display block can be driven.

In addition to the function of detecting a terminal and determining the display block it touches/approaches, the sensor unit 540 may perform the function of the sensor unit 140 shown in FIG. 1. That is, the sensor unit 540 may detect a region corresponding to the shape of the terminal which touches or approaches the display unit 530, and may output an image conversion signal to the image signal conversion unit 520 so as to brighten the image displayed in the detected region. In response to the input image conversion signal, the image signal conversion unit 520 converts the image signal such that the image of the region detected by the sensor unit 540 is converted into a bright image, that is, an image having a gray level higher than a predetermined reference gray level, and outputs the converted image signal to the display unit 530. If the image already has a gray level at or above the reference gray level, then the image is left unmodified, i.e. if the image is already sufficiently bright, it is not further brightened. Since this image conversion process has been described above with reference to FIG. 1, a detailed description thereof will be omitted.

The light source unit 550 includes a plurality of light source blocks corresponding respectively to the display blocks of the display unit 530. Thus, the light source unit 550 of the current exemplary embodiment includes a 3×3 grid of light source blocks. Each of the light source blocks provides light to a corresponding one of the display blocks. Here, at least one of the light source blocks transmits data by being turned on or off based on the input data signal. That is, That is, a terminal may touch or approach any one of the display blocks of the display unit 530 and receive an optical signal, which is based on a data signal, from the corresponding light source block.

Specifically, the light source unit 550 includes a data converter 551, the light source driver 552, and a light source 553 having a plurality of light source blocks.

The data converter 551 receives a data signal, converts the data signal based on a data transmission protocol such as a wireless optical communication protocol, and outputs the converted data signal to the light source driver 552. The light source driver 552 then drives the appropriate block of light source 553 according to this data signal.

Here, the luminance of a light source block may be varied by adjusting parameters of the data transmission protocol. That is, the luminance of a light source block may be adjusted at least partially according to the average luminance of the other light source blocks.

FIG. 6 is a diagram illustrating the concept of data transmission performed by the visible light communication apparatus 500 of FIG. 5. Referring to FIG. 6, an image is displayed on the display unit 530 of the visible light communication apparatus 500. The light source unit 550 provides light to the display unit 530 via a plurality of light source blocks, each of which illuminates a respective display block of the display unit 530.

A terminal MT having an optical sensor touches or approaches any one of the display blocks of the display unit 530 to receive a data signal. For example, terminals MT1 and MT2 may respectively touch or approach different display blocks B1 and B2, as shown in the drawing.

When the terminal MT1 touches or approaches the display block B1, the light source block located behind block B1 is driven according to a data signal, so as to transmit data to terminal MT1. Thus, the terminal MT1 can receive an optical signal, which is generated based on the data signal, from the display block B1.

Similarly, when the terminal MT2 touches or approaches the display block B2, the light source block located behind block B2 is driven according to a data signal, so as to transmit data to terminal MT2. Thus, the terminal MT2 can receive an optical signal, which is generated based on the data signal, from the display block B2. Here, the data signal which drives the light source block behind display block B2 may be the same or different from the data signal which drives the light source block behind display block B1.

The regions corresponding to the shapes of each of the terminals MT1 and MT2 display a brighter image having a higher gray level, as described above with reference to FIG. 3.

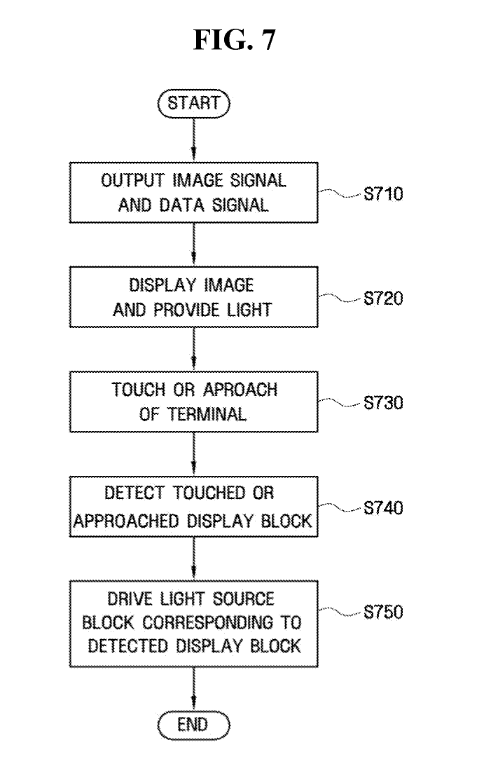

FIG. 7 is a flowchart illustrating a visible light communication method according to another exemplary embodiment of the present invention. Referring to FIG. 7, the broadcast signal reception unit 510 separates an image signal and a data signal from a broadcast signal, and outputs the image signal to the display unit 530 and the data signal to the light source unit 550 (operation S710). Here, the display unit 530 includes a plurality of display blocks, and the light source unit 550 includes a plurality of light source blocks each positioned to illuminate one of the display blocks.

The display unit 530 displays an image according to the input image signal, with each of the light source blocks of the light source unit 550 providing light to its corresponding display block in the same manner as a conventional backlight (operation S720).

A terminal can be brought into contact, or near contact, with any one of the display blocks of the display unit 530 in order to receive data from an optical signal that is generated based on the data signal (operation S730). The sensor unit 540 detects the area of the terminal or the terminal's shadow, identifies the display block that this terminal touches/approaches, and outputs a signal for driving the corresponding light source block (operation S740).

The light source unit 550 receives this signal, generates an optical signal based on the input data signal, and outputs this optical signal to the detected display block (operation S750). A method used by the light source unit 550 to output the optical signal is as described above with reference to FIG. 1. That is, the light source block corresponding to the detected display block is turned on or off so as to generate light pulses that correspond to the binary data signal. The overall luminance of the light source block is controlled by adjusting the data transmission protocol. Here, the luminance of the light source block which is driven based on the data signal may be controlled in view of the average luminance of the other light source blocks. For example, the duration of each ON pulse can be increased or decreased as desired (up to the maximum duration of each data bit), to control the luminance of this light source block relative to the other light source blocks. In the context of this invention, the term “average” may include not only an arithmetic average of luminance values, but also any luminance value in any way representative of any of the luminances of the remaining light source blocks. Furthermore, adjustments to the data transmission protocol may include the altering of any parameter of the protocol, such as the period of each ON pulse, the period or frequency of the data bits, or the like. Similarly, the luminance control section can employ any duration and sequence of bits suitable for identifying a particular desired luminance.

Although not shown in the drawing, operations S440 and S450 described above with reference to FIG. 4 may additionally be performed after operation S730. That is, an operation in which the sensor unit 540 detects a region corresponding to the shape of the terminal which touches or approaches the display unit 530 and an operation in which the image signal conversion unit 520 converts an image of the region detected by the sensor unit 540 into a bright image may additionally be performed.

The operations included in the visible light communication method according to the current exemplary embodiment may not necessarily be executed in the above order, and the order of the operations may vary.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A visible light communication apparatus, comprising:
a display unit that displays an image according to an image signal;
a light source unit that operates as a backlight for the display unit, generates an optical signal by driving a light source based on a data signal, and outputs the generated optical signal to the display unit;
a sensor unit that detects a region corresponding to a shape of a terminal which touches or approaches the display unit; and
an image signal conversion unit that converts the image signal such that an image displayed in the region detected by the sensor unit is converted to a bright image having a gray level higher than a predetermined reference gray level.

2. The apparatus of claim 1, wherein the bright image is an image in which a gray level of a blue color is higher than the predetermined reference gray level.

3. The apparatus of claim 2, wherein the bright image is a full-white image or a full-blue image.

4. The apparatus of claim 1, wherein the light source unit comprises:
a data converter that converts the data signal according to a predetermined data transmission protocol, so as to generate a converted data signal; and
a light source driver driving the light source according to the converted data signal,
wherein the data converter adjusts the data transmission protocol according to a luminance of the light source.

5. The apparatus of claim 1, wherein the terminal comprises:
an optical sensor receiving the optical signal; and
a demodulator determining the data signal by demodulating the received optical signal.

6. A visible light communication apparatus, comprising:
a display unit having a plurality of display blocks on which an image is to be displayed;
a light source unit having a plurality of light source blocks which correspond respectively to the display blocks, wherein each of the light source blocks is configured to output an optical signal to a corresponding one of the display blocks; and
a sensor unit that identifies a display block corresponding to a position of a terminal which touches or approaches the display unit,
wherein the light source unit is configured to generate an optical signal by driving the light source block corresponding to the identified display block, wherein the driving is based on a data signal of a broadcast signal, and wherein the driving outputs the generated optical signal to the identified display block.

7. The apparatus of claim 6, wherein the sensor unit is configured to detect a region of the display unit corresponding to a shape of the terminal, and wherein the apparatus further comprises an image signal conversion unit for converting an image signal such that an image displayed in the region detected by the sensor unit is converted to a bright image having a gray level higher than a predetermined reference gray level.

8. The apparatus of claim 6, wherein the light source unit comprises:
a data converter for converting the data signal according to a predetermined data transmission protocol, so as to generate a converted data signal; and
a light source driver driving the light source block according to the converted data signal,
wherein the data converter is configured to adjust the data transmission protocol according to a luminance of the light source block.

9. The apparatus of claim 7, wherein the bright image is an image in which a gray level of a blue color is higher than a predetermined reference gray level.

10. The apparatus of claim 9, wherein the bright image is a full-white image or a full-blue image.

11. The apparatus of claim 6, wherein the terminal comprises:
an optical sensor receiving the optical signal; and
a demodulator determining the data signal by demodulating the received optical signal.

12. A visible light communication method, comprising:
displaying an image on a display unit according to an image signal;
detecting a terminal touching or approaching the display unit;
detecting a region corresponding to a shape of the terminal that touches or approaches the display unit;
converting the image signal such that an image displayed in the detected region is converted to a bright image having a gray level higher than a predetermined reference gray level;
generating an optical signal by driving a light source based on a data signal; and
outputting the generated optical signal to the display unit.

13. The method of claim 12, wherein the bright image is an image in which a gray level of a blue color is higher than a predetermined reference gray level.

14. The method of claim 12, wherein the generating of the optical signal and the outputting of the generated optical signal to the display unit comprises:
converting the data signal according to a predetermined data transmission protocol; and
driving the light source according to the converted data signal,
wherein the data transmission protocol is adjusted according to a luminance of the light source.

15. A visible light communication method, comprising:
displaying an image on a display unit according to an image signal, the display unit having a plurality of display blocks;
detecting a terminal touching or approaching any one of the display blocks;
identifying a display block corresponding to a position of the touching or approaching terminal;
generating an optical signal by driving a light source block that corresponds to the identified display block, wherein the driving is based on a data signal; and
outputting the generated optical signal to the identified display block.

16. The method of claim 15 further comprising, after the detecting a terminal:
detecting a region corresponding to a shape of the touching or approaching terminal; and
converting the image signal such that an image displayed in the detected region is converted to a bright image having a gray level higher than a predetermined reference gray level.

17. The method of claim 16, wherein the bright image is an image in which a gray level of a blue color is higher than a predetermined reference gray level.

18. The method of claim 15, wherein the generating of the optical signal and the outputting of the generated optical signal to the detected display block comprise:
converting the data signal according to a predetermined data transmission protocol; and
driving the light source block according to the converted data signal,
wherein the data transmission protocol is adjusted according to a luminance of the light source block.
